(19) United States
(12) Patent Application Publication
(10) Pub. No.: US 2025/0170012 A1
(43) Pub. Date: May 29, 2025

(54) APPARATUS AND METHOD FOR TREATING CONNECTIVE TISSUES

(71) Applicant: Fascial Restructuring Inc., Ottawa (CA)

(72) Inventor: Adam CLIMIE, Ottawa (CA)

(21) Appl. No.: 18/962,643

(22) Filed: Nov. 27, 2024

Related U.S. Application Data
(60) Provisional application No. 63/603,672, filed on Nov. 29, 2023.

(51) Int. Cl. A61H 7/00

(52) U.S. Cl. CPC A61H 7/001; A61H 7/003; A61H 2205/081

(57) ABSTRACT

An apparatus for treating tissue is provided. The apparatus comprises an elongated member and a first support member at a first end of the elongated member. The elongated member comprises a first pressure location and a second pressure location, the first pressure location being at a second end of the elongated member opposite the first end, and a second support member between the first and second pressure locations. In a first mode of use, the first and second support members rest on the same plane, and in a second mode of use, the second support member is a handle.

### CROSS-REFERENCE TO RELATED APPLICATIONS

The present application claims priority to U.S. Provisional Patent Application No. 63/603,672 entitled “Apparatus and Method for Treating Connective Tissues” filed on Nov. 29, 2023.

### TECHNICAL FIELD

The present disclosure relates to a self-treatment therapy tool, and in particular to a manual therapy self-treatment tool for relieving connective tissues.

### BACKGROUND

Pain in the body is experienced by many people. To treat the pain, a doctor, physiotherapist, chiropractor or therapist may be consulted. In cases such as lower back or hip pain, the root of the pain may be due to tight muscles or connective tissues. Various therapists can treat such pain by massages or using particular tools to relieve and release tissues that are causing the pain.

There are some tools that a person may use to treat themselves to try to relieve the pain. For example, balls or rollers may be used to apply pressure and massage various areas of the body. However, these balls and rollers rely on a user's body weight or gravity to apply adequate pressure. Other tools, such as handheld tools, are also used. However, these tools may not allow a user to apply to adequate pressure to relieve the pain.

Accordingly, an additional, alternative, and/or improved tool for self-treatment of body pain is desired.

### SUMMARY

In accordance with an aspect of the present disclosure, there is provided an apparatus for treating tissue. The apparatus includes an elongated member and a first support member at a first end of the elongated member. The elongated member includes a first pressure location and a second pressure location. The first pressure location is at a second end of the elongated member opposite the first end. The elongated member further includes a second support member between the first and second pressure locations. In a first mode, the first and second support members rest on the same plane, and in a second mode, the second support member is a handle.

In a further aspect of the apparatus, the apparatus may be formed as a single component.

In a further aspect of the apparatus, the apparatus may be molded as a single component.

In a further aspect of the apparatus, the tissue may be connective tissue.

In a further aspect of the apparatus, the apparatus may be for treatment of lower back pain.

In a further aspect of the apparatus and in the first mode, the first and second support members are placed on a ground, and the second pressure location is located higher than the first pressure location.

In a further aspect of the apparatus, the first pressure location extends away from the second support member.

In a further aspect of the apparatus, the first pressure location has a rounded end.

In a further aspect of the apparatus, the second pressure location is rounded in shape.

In a further aspect of the apparatus, the apparatus is formed as a hollow tool.

In a further aspect of the apparatus, the apparatus further includes a plurality of reinforcing ribs formed on a bottom side of the apparatus.

In a further aspect of the apparatus, the reinforcing ribs are exposed from the apparatus.

### BRIEF DESCRIPTION OF THE DRAWINGS

Further features and advantages of the present disclosure will become apparent from the following detailed description, taken in combination with the appended drawings, in which:

FIG. 1 depicts a perspective view of an embodiment of a self-treatment tool on a ground surface;

FIG. 2 depicts another perspective view of the embodiment of FIG. 1;

FIGS. 3A-3C depict side, top, and front views of the embodiment of FIG. 1;

FIG. 3D depicts a bottom perspective view of an embodiment of the tool; and

FIGS. 4A-4C depict uses of the self-treatment tool on a ground surface.

### DETAILED DESCRIPTION

An apparatus and method for treating tissue, such as connective tissue, is provided. The apparatus may be manual self-treatment tool for applying pressure to the tissue. The apparatus comprises an elongated member and a first support member at a first end of the elongated member. The elongated member comprises a first pressure location at a second end of the elongated member opposite the first end, a second pressure location, and a second support member between the first and second pressure locations. In a first mode of use, the first and second support members rest on the same plane. In a second mode of use, the second support member acts as a handle in a second mode.

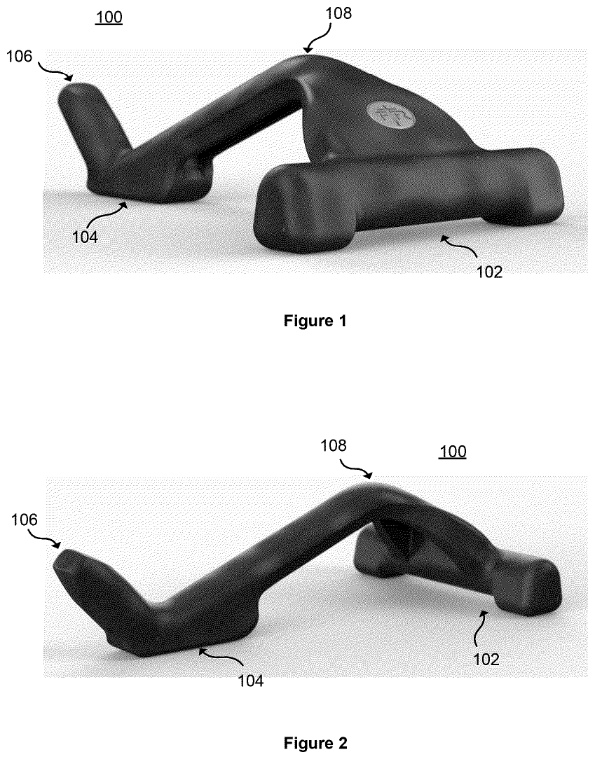

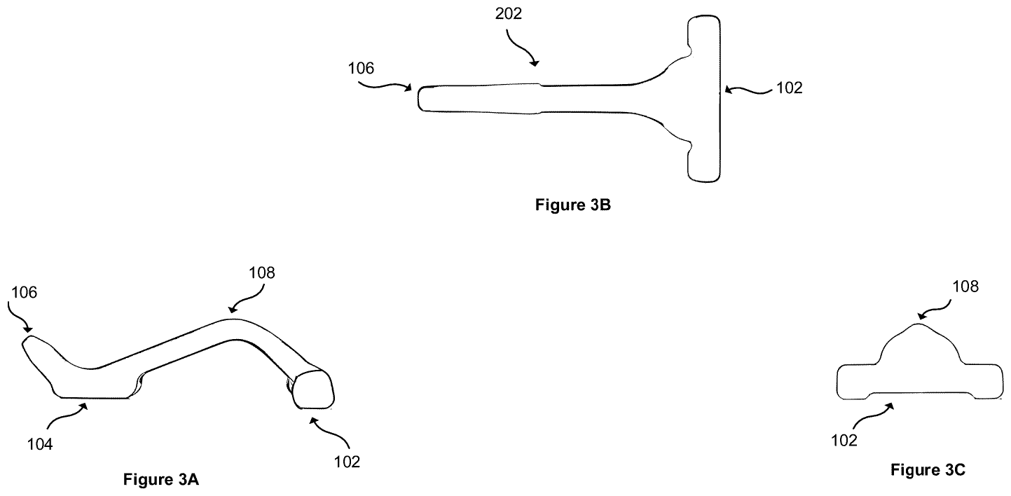

FIGS. 1 and 2 depict perspective views of an embodiment of the self-treatment tool or device 100. The tool 100 may be used to manually treat pain in the body such as lower back pain by massaging and releasing fascia tissue and muscles. The tool 100 comprises a first support member 102 at an end of the tool, and a second support member 104. As depicted, the support members 102, 104 may be used to anchor and stabilize the device 100 on a surface. The tool 100 further comprises a first pressure location 106 at an opposite end of the tool, and a second pressure location 108 between the support members 102, 104. The pressure locations 106, 108 may be used to apply pressure to certain areas of the body to massage and release the tissue and muscles.

In a first mode, the support members 102, 104 are placed on a surface, such as the ground. The support members 102, 104 are shaped to stabilize and anchor the tool 100 on the surface. It will be appreciated that, in some embodiments, the support members 102, 104 may include textured surfaces to better stabilize the tool on the surface by providing more friction. While the tool 100 is positioned on the surface, such as the ground, a user may lay on top of the tool 100 and rest a particular area of the body on the pressure location 108. In this mode, gravity may be used to compress the user's muscular tissue that is on or near the pressure location 108. The user may then pull their body against the pressure location 108 to create a shearing force. Such a shearing force allows the adhesion within fascia or connective tissues to be separated, allowing the fascia to lengthen quickly and efficiently. The downward pressure from gravity and the shearing force from the user's movement may allow the muscular fascia to be released 3-dimensionally, providing relief for the user.

It will be appreciated that although the tool 100 is depicted as resting on the ground, the tool 100 may instead be positioned on a wall or other surface, where the user would use their body weight to apply shearing forces on their body using the pressure location 108 to release and treat their tissues.

In a second mode of use, the support member 102 acts as a handle. A user can hold the tool 100 using support member 102, and apply pressure to various muscular tissues on their body using pressure location 106. Pressure location 106 may have a hooked shape, as depicted, to apply appropriate pressure to various areas of the body. For example, the user may direct the pressure location 106 into their abdominal region to release the iliopsoas muscle group where it attaches to the inside of the pelvis, as well as the front of the lumbar spine. This pressure at the abdominal region allows for a release of the lumbar attachments of the diaphragm which intersect with the psoas major muscle on the front of the spine. Such pressure allows the user to massage and release the connective tissues to provide relief from the pain being experienced.

In the second mode, where the support member 102 is used as a handle, the tool 100 may be used to release and massage other muscle tissues that may be difficult to access using the first mode.

As depicted in FIGS. 1 and 2, the first pressure location 106 extends away from the second support member 104, such that the second support member 104 can be effectively in contact with the user's body when in the second mode. As also depicted in FIGS. 1 and 2, the first pressure location 106 may have a rounded end, such that the first pressure location 106 is less likely to cause pain when the user is using the tool 100 in the second mode. As also depicted in FIGS. 1 and 2, the second pressure location 108 is rounded in shape, such that it is less likely to cause pain when the user is using the tool 100 in the first mode.

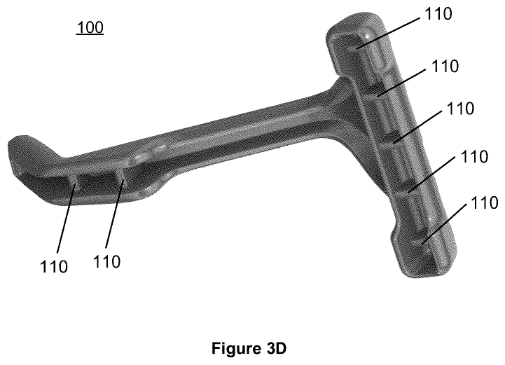

FIGS. 3A-3C depict side, top, and front views of the self-treatment tool or device 100. As depicted in FIG. 3A, when the tool 100 is resting on a surface, both support members 102, 104 rest on the surface or rest on the same plane. Although two support members are described and depicted, the tool 100 may comprise additional support members to better stabilize the tool 100 on one or more surfaces or planes. As depicted in FIG. 3A, when the tool 100 is resting on the surface (i.e., in the first mode), the second pressure location 108 is located higher than the first pressure location 106, such that the second pressure location 108 can be effectively in contact with the user's body without having the first pressure location 106 in the way.

The tool 100 comprises an elongated member 202 comprising the support member 104 and the pressure locations 106, 108. The elongated member 202 may have a generally straight shape when viewed from a top side, as depicted in FIG. 3B, or it may have another shape with additional curves or points. From a side view, the elongated member curves to form the pressure locations 106, 108. The support member 102 extends perpendicular to the elongated member 202, and may comprise ridges or textured surfaces to provide better grip for the user and additional friction for the surfaces. It will be appreciated that the support member 102 may be positioned at a different angle relative to the elongated member 202 or may have a different shape so long as the support member 102 provides a stabilizing surface for the tool 100, and can act as a handle.

As depicted in FIGS. 1 and 2, the tool 100 may be molded as a single component. The tool 100 may be manufactured using injection molding such as plastic injection molding, and may be formed of fibre-reinforced plastic. When formed by injection molding or other similar processes, the tool 100 may be formed as a hollow tool with a plurality of reinforcing ribs 110 as depicted in FIG. 3D, where the reinforcing ribs 110 are formed on a bottom side of the tool 100 and may be exposed from the tool 100. It will be appreciated that in some embodiments, the tool 100 may comprise multiple components that are connected together to form the tool 100.

As described above, the tool 100 may be used to help relieve pain in the body, such as lower back pain. The tool 100 is shaped and formed such that it can access many areas of the body to provide pressure to the tissues and to allow the user to pull against or with the tool to massage and release the tissues. For example, the tool 100 may be used to access the entire length of the psoas or iliacus and diaphragm muscles. It may be used to release and massage all other hip flexors as well.

In some embodiments, the tool 100 may be provided with instructions for use of the tool on different areas of the body and for different pain treatment. The instructions may be provided via, for example, a booklet or videos.

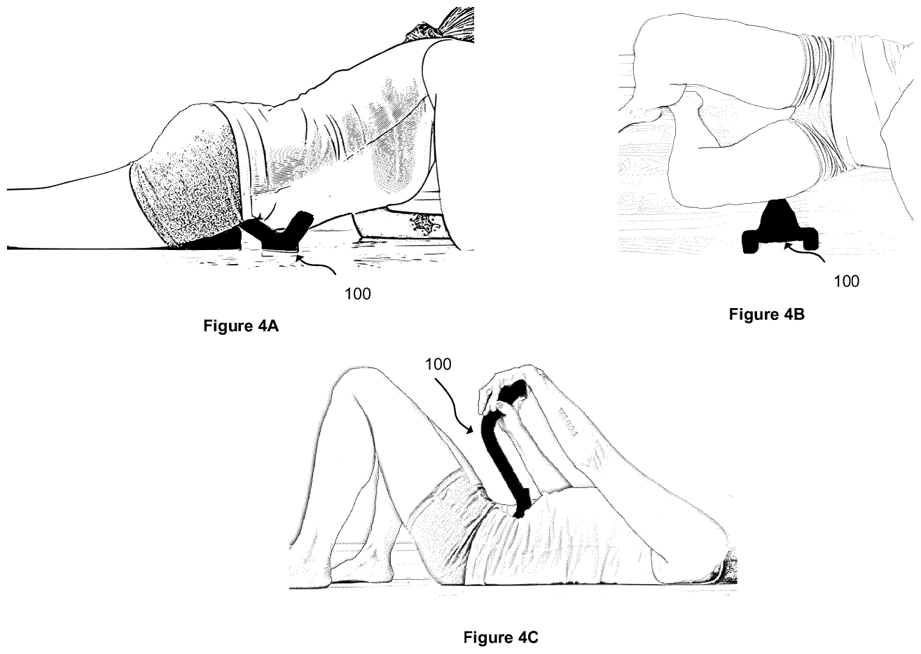

FIGS. 4A-C depict uses of the self-treatment tool on a ground surface. FIG. 4A depicts the tool 100 being used in the first mode, positioned on a ground surface while a user rests a particular area of the body on pressure location 108. In this mode, gravity is used to compress the user's muscular tissue that is on or near the pressure location 108 such that the user can pull their body against pressure location 108 to create a shearing force. FIG. 4B depicts another embodiment of the tool 100 in a first mode, where the user is resting a particular area of the side of their body on pressure location 108.

FIG. 4C depicts the tool 100 being used in the second mode. The user is holding the tool 100 using support member 102, and applying pressure to a particular muscular tissue on their body using pressure location 106. Using the support member 102 as a handle allows the user to massage and release the connective tissues with pressure location 106.

It will be apparent to persons skilled in the art that a number of variations and modifications can be made without departing from the scope of the invention. Although specific embodiments are described herein, it will be appreciated that modifications may be made to the embodiments without departing from the scope of the current teachings. For simplicity and clarity of the illustration, elements in the figures are not necessarily to scale, are only schematic and are non-limiting of the element's structures. It will be apparent to persons skilled in the art that a number of variations and modifications can be made without departing from the scope of the invention as described herein.

1. An apparatus for treating tissue, the apparatus comprising
an elongated member; and
a first support member at a first end of the elongated member, the elongated member comprising:
a first pressure location and a second pressure location, the first pressure location being at a second end of the elongated member opposite the first end; and
a second support member between the first and second pressure locations,
wherein, in a first mode, the first and second support members rest on the same plane, and
in a second mode, the second support member is a handle.

2. The apparatus of claim 1, wherein the apparatus is formed as a single component.

3. The apparatus of claim 1, wherein the apparatus is molded as a single component.

4. The apparatus of claim 1, wherein the tissue is connective tissue.

5. The apparatus of claim 1, wherein the apparatus is for treatment of lower back pain.

6. The apparatus of claim 1, wherein, in the first mode, the first and second support members are placed on a ground, and the second pressure location is located higher than the first pressure location.

7. The apparatus of claim 1, wherein the first pressure location extends away from the second support member.

8. The apparatus of claim 1, wherein the first pressure location has a rounded end.

9. The apparatus of claim 1, wherein the second pressure location is rounded in shape.

10. The apparatus of claim 1, wherein the apparatus is formed as a hollow tool.

11. The apparatus of claim 10, further comprising a plurality of reinforcing ribs formed on a bottom side of the apparatus.

12. The apparatus of claim 11, wherein the reinforcing ribs are exposed from the apparatus.
